(19) United States
(12) Patent Application Publication
(10) Pub. No.: US 2026/0241699 A1
(43) Pub. Date: Aug. 20, 2026

(54) LIQUID EJECTION APPARATUS

(71) Applicant: SEIKO EPSON CORPORATION, Tokyo (JP)

(72) Inventors: Daisuke ARAGAKI, SHIOJIRI-SHI (JP); Makoto SAWADAISHI, SHIOJIRI-SHI (JP)

(21) Appl. No.: 19/544,261

(22) Filed: Feb. 19, 2026

(30) Foreign Application Priority Data
Feb. 19, 2025 (JP) 2025-025266

(51) Int. Cl. B41J 2/175; F16K 7/12

(52) U.S. Cl. CPC B41J 2/17596; F16K 7/12

(57) ABSTRACT

A liquid ejection head configured to eject a liquid from a nozzle, a supply flow path configured to allow the liquid to be supplied from a liquid storage portion storing the liquid to the liquid ejection head, a branch flow path branching from the supply flow path, and a supply valve capable of opening and closing the supply flow path are provided. The supply valve includes a first liquid chamber provided in the supply flow path, a second liquid chamber provided in the branch flow path, and a diaphragm partitioning the first liquid chamber and the second liquid chamber. The first liquid chamber includes an inflow port into which the liquid flows and an outflow port from which the liquid flows out, and when a pressure of the first liquid chamber is lower than a pressure of the second liquid chamber, the diaphragm is displaced in a direction of reducing a volume of the first liquid chamber to close the outflow port.

The present application is based on, and claims priority from JP Application Serial Number 2025-025266, filed Feb. 19, 2025, the disclosure of which is hereby incorporated by reference herein in its entirety.

### BACKGROUND

### 1. Technical Field

The present disclosure relates to a liquid ejection apparatus such as a printer.

### 2. Related Art

For example, as in JP-A-2009-160913, there is a liquid jet apparatus which is an example of a liquid ejection apparatus. The liquid jet apparatus includes a liquid supply flow path which is an example of a supply flow path, an ejection-side valve which is an example of a supply valve, and a liquid jet head which is an example of a liquid ejection head. The ejection-side valve is provided in the liquid supply flow path. The ejection-side valve includes an ejection-side valve body which is an example of a diaphragm. The ejection-side valve body opens and closes the liquid supply flow path by being deformed according to a pressure of a liquid in the liquid supply flow path.

JP-A-2009-160913 is an example of the related art.

In the ejection-side valve body in JP-A-2009-160913, one surface is in contact with the liquid, whereas an opposite surface is in contact with air. Therefore, there is a possibility that air passes through the ejection-side valve body and enters the liquid supply flow path.

### SUMMARY

According to an aspect of the disclosure, there is provided a liquid ejection apparatus including: a liquid ejection head configured to eject a liquid from a nozzle; a supply flow path configured to allow the liquid to be supplied from a liquid storage portion storing the liquid to the liquid ejection head; a branch flow path branched from the supply flow path; and a supply valve configured to open and close the supply flow path. The supply valve includes a first liquid chamber provided in the supply flow path, a second liquid chamber provided in the branch flow path, and a diaphragm partitioning the first liquid chamber and the second liquid chamber, the first liquid chamber includes an inflow port into which the liquid flows and an outflow port from which the liquid flows out, and when a pressure of the first liquid chamber is lower than a pressure of the second liquid chamber, the diaphragm is displaced in a direction of reducing a volume of the first liquid chamber to close the outflow port.

### BRIEF DESCRIPTION OF THE DRAWINGS

FIG. 1 is a schematic diagram of one embodiment of a liquid ejection apparatus.

FIG. 2 is a schematic view of a supply valve.

### DESCRIPTION OF EMBODIMENTS

### Embodiment

An embodiment of a liquid ejection apparatus will hereinafter be described with reference to the drawings. The liquid ejection apparatus is, for example, an inkjet type printer that performs printing by ejecting ink as an example of a liquid onto a medium such as a piece of paper, a fabric, vinyl, a plastic component, or a metal component.

### Liquid Ejection Apparatus

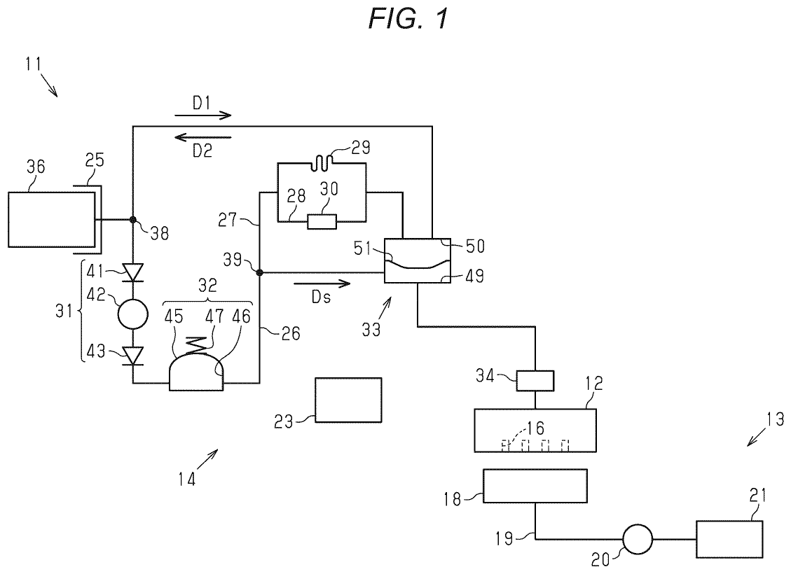

As shown in FIG. 1, a liquid ejection apparatus 11 may include a liquid ejection head 12, a maintenance mechanism 13, and a liquid supply device 14.

The liquid ejection head 12 includes one or more nozzles 16. The liquid ejection head 12 can eject a liquid from the nozzles 16. The liquid ejection head 12 ejects the liquid from the nozzles 16 to perform printing on a medium (not shown).

### Maintenance Mechanism

The maintenance mechanism 13 may include a cap 18, a discharge flow path 19, and an aspiration unit 20. The discharge flow path 19 may be coupled to a waste liquid storage portion 21. The waste liquid storage portion 21 may be detachably provided in the liquid ejection apparatus 11.

The cap 18 can come into contact with the liquid ejection head 12 and form a closed space in which the nozzles 16 open. The cap 18 can receive the liquid discharged from the nozzles 16. The cap 18 may be provided to be movable to a capping position (not shown) and a separation position shown in FIG. 1.

The capping position is a position in contact with the liquid ejection head 12. The cap 18 located at the capping position forms the closed space when an opening of the cap 18 is closed by the liquid ejection head 12. The cap 18 located at the capping position caps the liquid ejection head 12.

The separation position is a position where the liquid ejection head 12 is opened. The cap 18 located at the separation position is separated from the liquid ejection head 12, and the opening of the cap 18 is opened. The cap 18 located at the separation position opens the space in the cap 18.

The discharge flow path 19 has an upstream end coupled to the space in the cap 18 and a downstream end coupled to the waste liquid storage portion 21. The discharge flow path 19 may be configured with, for example, a tube that is deformable following the movement of the cap 18. The discharge flow path 19 can discharge the liquid in the cap 18 to the waste liquid storage portion 21.

The aspiration unit 20 may be provided in the discharge flow path 19. The aspiration unit 20 is, for example, a tube pump. The aspiration unit 20 can depressurize the space in the cap 18 via the discharge flow path 19.

The maintenance mechanism 13 performs aspiration cleaning of discharging the liquid from the nozzles 16 by causing the aspiration unit 20 to depressurize the inside of the cap 18 in a state where the cap 18 is located at the capping position.

### Liquid Supply Device

The liquid supply device 14 may include a control unit 23. The control unit 23 integrally controls driving of each mechanism in the liquid supply device 14 and controls various operations executed in the liquid supply device 14. The control unit 23 may control each main operation executed by the liquid ejection apparatus 11.

The control unit 23 can be configured as a circuit including α: one or more processors that execute various kinds of processing according to a computer program, β: one or more dedicated hardware circuits that execute at least some of the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute processing. The memory, that is, a computer-readable medium includes any readable medium that can be accessed by a general-purpose or dedicated computer.

The liquid supply device 14 may include a mounting portion 25, a supply flow path 26, a branch flow path 27, and a parallel flow path 28. The liquid supply device 14 may include a resistance flow path 29 and a regulator 30. The liquid supply device 14 may include a liquid feeding portion 31, a buffer 32, a supply valve 33, and a pressure regulating valve 34.

The liquid supply device 14 can be coupled to the liquid ejection head 12. The liquid supply device 14 supplies the liquid to the liquid ejection head 12 from a liquid storage portion 36 mounted on the mounting portion 25. The liquid flows through the supply flow path 26 in a supply direction Ds.

The liquid storage portion 36 may be detachably mounted on the mounting portion 25. The liquid storage portion 36 stores the liquid.

An upstream end of the supply flow path 26 in the supply direction Ds is coupled to the liquid storage portion 36. The upstream end of the supply flow path 26 may be, for example, a hollow needle that pierces the liquid storage portion 36. The upstream end of the supply flow path 26 may be provided in the mounting portion 25. The supply flow path 26 is coupled to the liquid storage portion 36 mounted on the mounting portion 25, such that the liquid stored in the liquid storage portion 36 can be led out. A downstream end of the supply flow path 26 in the supply direction Ds is coupled to the liquid ejection head 12. The supply flow path 26 supplies the liquid from the liquid storage portion 36 to the liquid ejection head 12.

The supply flow path 26 is provided with a first coupling portion 38 and a second coupling portion 39. The first coupling portion 38 is provided upstream of the liquid feeding portion 31. The first coupling portion 38 may be provided between the upstream end of the supply flow path 26 and the liquid feeding portion 31. The second coupling portion 39 is provided downstream of the liquid feeding portion 31. The second coupling portion 39 is provided between the liquid feeding portion 31 and the pressure regulating valve 34. The second coupling portion 39 may be provided between the buffer 32 and the supply valve 33.

The branch flow path 27 branches from the supply flow path 26. The branch flow path 27 may be coupled to the first coupling portion 38 and the second coupling portion 39. That is, the branch flow path 27 may branch from the supply flow path 26 at the first coupling portion 38 and join the supply flow path 26 at the second coupling portion 39. The branch flow path 27 may branch from the supply flow path 26 at the second coupling portion 39 and join the supply flow path 26 at the first coupling portion 38.

The liquid can flow through the branch flow path 27 in a first branch direction D1 and a second branch direction D2 opposite to the first branch direction D1. The first branch direction D1 is a direction from the first coupling portion 38 toward the second coupling portion 39. The second branch direction D2 is a direction from the second coupling portion 39 toward the first coupling portion 38.

The resistance flow path 29 is provided in the branch flow path 27. A cross-sectional area of the resistance flow path 29 may be smaller than a cross-sectional area of the branch flow path 27. The resistance flow path 29 may be thinner than the branch flow path 27. The resistance flow path 29 may meander. The resistance flow path 29 increases a resistance of the branch flow path 27. Specifically, the resistance of the branch flow path 27 is larger than a resistance of the supply flow path 26 between the liquid feeding portion 31 and the pressure regulating valve 34. The resistance of the branch flow path 27 is larger than the resistance of the supply flow path 26 between the second coupling portion 39 and the pressure regulating valve 34. The resistance flow path 29 makes a flow rate of the liquid flowing through the branch flow path 27 smaller than a flow rate of the liquid flowing through the supply flow path 26.

The parallel flow path 28 is provided in parallel with the branch flow path 27. The parallel flow path 28 is coupled to both sides of the resistance flow path 29. Specifically, the parallel flow path 28 is coupled to the branch flow path 27 between the resistance flow path 29 and the first coupling portion 38 and the branch flow path 27 between the resistance flow path 29 and the second coupling portion 39. The parallel flow path 28 according to the present embodiment is coupled to the branch flow path 27 between the resistance flow path 29 and the supply valve 33.

The regulator 30 is provided in the parallel flow path 28. The regulator 30 opens and closes the parallel flow path 28 according to a pressure difference between the parallel flow path 28 on a first coupling portion 38 side and the parallel flow path 28 on a second coupling portion 39 side. When the pressure difference is small, the regulator 30 closes the parallel flow path 28. When the pressure difference becomes larger than a set pressure, the regulator 30 opens the parallel flow path 28.

The liquid feeding portion 31 is provided in the supply flow path 26 upstream of the supply valve 33. The liquid feeding portion 31 is provided in the supply flow path 26 upstream of the pressure regulating valve 34. The liquid feeding portion 31 may be provided between the first coupling portion 38 and the buffer 32. The liquid feeding portion 31 feeds the liquid in the supply direction Ds. The liquid feeding portion 31 pressurizes and supplies the liquid to the liquid ejection head 12. The liquid feeding portion 31 may include a first one-way valve 41, a supply pump 42, and a second one-way valve 43.

The supply pump 42 is provided between the first one-way valve 41 and the second one-way valve 43. The supply pump 42 is, for example, a diaphragm pump.

The first one-way valve 41 is provided upstream of the supply pump 42. The second one-way valve 43 is provided downstream of the supply pump 42. The first one-way valve 41 and the second one-way valve 43 allow the liquid to flow downstream in the supply direction Ds and restrict a flow of the liquid upstream.

The buffer 32 is provided in the supply flow path 26 between the liquid feeding portion 31 and the second coupling portion 39. The buffer 32 stabilizes the pressure of the liquid flowing through the supply flow path 26. The buffer 32 may include a flexible member 45, a storage chamber 46, and a supply spring 47.

The storage chamber 46 is provided in the supply flow path 26. The storage chamber 46 stores the liquid. The flexible member 45 forms a part of a wall surface of the storage chamber 46. The flexible member 45 is deflectable and deformable. The flexible member 45 changes a volume of the storage chamber 46. The supply spring 47 pushes the flexible member 45 from the outside of the storage chamber 46. The supply spring 47 applies a supply pressure to the liquid in the storage chamber 46.

The pressure regulating valve 34 is provided in the supply flow path 26 downstream of the supply valve 33. The pressure regulating valve 34 stabilizes the pressure of the liquid supplied to the nozzles 16 by regulating the pressure of the pressurized and supplied liquid. The pressure regulating valve 34 regulates the pressure of the liquid in the liquid ejection head 12 to a pressure at which a meniscus is formed in the nozzles 16. The pressure regulating valve 34 opens the supply flow path 26 when a downstream pressure is lower than a predetermined pressure. For example, when the liquid is ejected from the nozzles 16 or the liquid is aspirated from the nozzles 16, the liquid in the liquid ejection head 12 decreases and the pressure of the liquid decreases. When the downstream negative pressure increases, the pressure regulating valve 34 opens the supply flow path 26 to supply the liquid to the liquid ejection head 12.

### Supply Valve

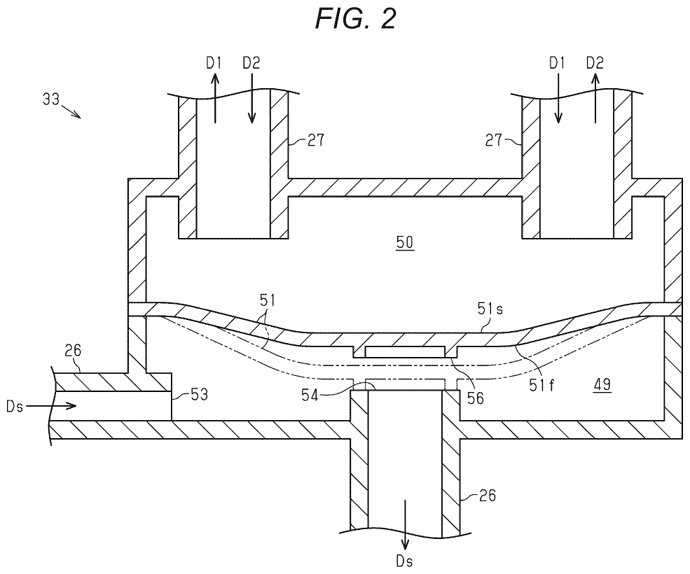

As shown in FIG. 2, the supply valve 33 can open and close the supply flow path 26. The supply valve 33 includes a first liquid chamber 49, a second liquid chamber 50, and a diaphragm 51.

The first liquid chamber 49 is provided in the supply flow path 26. The first liquid chamber 49 has an inflow port 53 and an outflow port 54. The liquid flows into the first liquid chamber 49 from the inflow port 53. The liquid in the first liquid chamber 49 flows out from the outflow port 54.

The second liquid chamber 50 is provided in the branch flow path 27. The second liquid chamber 50 may be provided between the resistance flow path 29 and the first coupling portion 38.

The diaphragm 51 partitions the first liquid chamber 49 and the second liquid chamber 50. The diaphragm 51 includes a first surface 51f and a second surface 51s.

The first surface 51f is a surface opposite to the second surface 51s. The first surface 51f forms the first liquid chamber 49. The first surface 51f receives the pressure of the liquid in the first liquid chamber 49. The first surface 51f receives the pressure of the liquid in the supply flow path 26.

The second surface 51s forms the second liquid chamber 50. The second surface 51s receives the pressure of the liquid in the second liquid chamber 50. The second surface 51s receives the pressure of the liquid in the branch flow path 27.

The diaphragm 51 is bent and deformed according to pressures of the first liquid chamber 49 and the second liquid chamber 50. The diaphragm 51 is displaceable between an open position indicated by a solid line in FIG. 2 and a closed position indicated by a two-dot chain line in FIG. 2.

The diaphragm 51 may include a seal portion 56. The seal portion 56 is provided on the first surface 51f. The seal portion 56 faces the outflow port 54. The seal portion 56 may have an annular shape. The diaphragm 51 located at the open position opens the outflow port 54. The diaphragm 51 located at the closed position closes the outflow port 54. In the diaphragm 51 located at the closed position, the seal portion 56 surrounds the outflow port 54.

When the pressure of the first liquid chamber 49 is lower than the pressure of the second liquid chamber 50, the diaphragm 51 is displaced in a direction of reducing a volume of the first liquid chamber 49 to close the outflow port 54. The diaphragm 51 opens the outflow port 54 when a pressure difference between the first liquid chamber 49 and the second liquid chamber 50 is small and when the pressure of the first liquid chamber 49 is larger than the pressure of the second liquid chamber 50.

### Functions of Present Embodiment

Functions of the present embodiment will be described.

In a standby state in which printing is not performed on the medium, the liquid feeding portion 31 stops driving and closes the supply flow path 26. The supply flow path 26 upstream of the liquid feeding portion 31 and the supply flow path 26 downstream of the liquid feeding portion 31 are coupled by the branch flow path 27. The pressures of the branch flow path 27 and the supply flow path 26 upstream of the pressure regulating valve 34 are balanced. Since the pressure difference between the first liquid chamber 49 and the second liquid chamber 50 decreases, the supply valve 33 opens the supply flow path 26. For example, when the liquid evaporates from the nozzles 16 and the pressure regulating valve 34 opens, the liquid flows through the branch flow path 27 in the first branch direction D1 and is supplied to the liquid ejection head 12.

In a printing state in which printing is performed on the medium, the control unit 23 drives the liquid feeding portion 31. The liquid feeding portion 31 pressurizes the liquid downstream of the liquid feeding portion 31 by feeding the liquid in the supply direction Ds. When the liquid feeding portion 31 is driven, a pressure of the first coupling portion 38 is lower than a pressure of the second coupling portion 39. The liquid in the supply flow path 26 flows into the branch flow path 27 from the second coupling portion 39. The liquid flowing into the branch flow path 27 flows in the second branch direction D2, passes through the second liquid chamber 50, and then flows out from the first coupling portion 38 to the supply flow path 26.

The liquids in the first liquid chamber 49 and the second liquid chamber 50 are both pressurized. However, since the flow rate of the branch flow path 27 is reduced by the resistance flow path 29, the pressure of the second liquid chamber 50 is lower than the pressure of the first liquid chamber 49. The supply valve 33 opens the supply flow path 26. The liquid is supplied to the liquid ejection head 12 in accordance with the ejection of the liquid.

When the liquid storage portion 36 becomes empty during printing, the control unit 23 stops driving the liquid feeding portion 31. The control unit 23 may notify a user to replace the liquid storage portion 36. Even when the supply of the liquid by the liquid feeding portion 31 is stopped, the buffer 32 supplies the stored liquid. That is, the supply pressure of the supply spring 47 is applied to the first liquid chamber 49. Since the flow rate of the branch flow path 27 is reduced, the liquid supplied from the buffer 32 is more easily sent to the first liquid chamber 49 than the second liquid chamber 50. Therefore, the supply valve 33 opens the supply flow path 26 in the same manner as when the liquid feeding portion 31 is driven. By providing the buffer 32, it is possible to continue printing by an amount of the stored liquid even after the driving of the liquid feeding portion 31 is stopped.

As maintenance of the liquid ejection head 12, the control unit 23 may execute choke cleaning. When the choke cleaning is performed, the control unit 23 stops driving the liquid feeding portion 31. The control unit 23 positions the cap 18 at the capping position and drives the aspiration unit 20. When the aspiration unit 20 aspirates the closed space of the cap 18, the liquid is discharged from the nozzles 16. When the liquid is discharged, a pressure on a liquid ejection head 12 side decreases, and thus the pressure regulating valve 34 opens the supply flow path 26. That is, the aspiration unit 20 can depressurize the first liquid chamber 49 by aspirating the closed space of the cap 18.

The resistance flow path 29 is located between the first liquid chamber 49 and the second liquid chamber 50. Therefore, the second liquid chamber 50 is less likely to be affected by the aspiration by the aspiration unit 20. In other words, the pressure in the second liquid chamber 50 is less likely to decrease than that in the first liquid chamber 49. Since the pressure of the first liquid chamber 49 becomes smaller than the pressure of the second liquid chamber 50, the diaphragm 51 is displaced to the closed position so as to reduce the volume of the first liquid chamber 49. That is, when the first liquid chamber 49 is depressurized by the aspiration unit 20, the diaphragm 51 is displaced in a direction of reducing the volume of the first liquid chamber 49 to close the outflow port 54. When the supply valve 33 closes the supply flow path 26, a negative pressure is stored downstream of the supply valve 33.

When the negative pressure is sufficiently stored, the control unit 23 drives the liquid feeding portion 31. The liquid feeding portion 31 displaces the diaphragm 51 to the open position by supplying the pressurized liquid to the first liquid chamber 49. When the supply valve 33 opens the supply flow path 26, the liquid is vigorously supplied to the liquid ejection head 12 by the negative pressure stored downstream.

### Effects of Present Embodiment

Effects of the present embodiment will be described.
(1-1) The first liquid chamber 49 is provided in the supply flow path 26. The diaphragm 51 partitions the first liquid chamber 49 and the second liquid chamber 50. That is, the liquid in the first liquid chamber 49 comes into contact with the first surface 51f of the diaphragm 51. The liquid in the second liquid chamber 50 comes into contact with the second surface 51s of the diaphragm 51. Therefore, entry of air into the supply flow path 26 can be prevented.
(1-2) The liquid feeding portion 31 feeds the liquid in the supply direction Ds. The pressure regulating valve 34 regulates the pressure of the liquid fed by the liquid feeding portion 31. Therefore, it is possible to stably supply the liquid to the liquid ejection head 12.
(1-3) The branch flow path 27 is coupled to the first coupling portion 38 upstream of the liquid feeding portion 31 and the second coupling portion 39 downstream of the liquid feeding portion 31. When the liquid feeding portion 31 feeds the liquid in the supply direction Ds, the liquid also flows to the branch flow path 27. Therefore, since the liquid in the second liquid chamber 50 can be caused to flow, it is possible to reduce a possibility that foreign matters such as air bubbles stay in the second liquid chamber 50.
(1-4) In the so-called choke cleaning in which the supply flow path 26 is closed to store the negative pressure and then the liquid is vigorously discharged, the liquid chamber is depressurized. Therefore, when the diaphragm 51 is in contact with air, the air that passes through the diaphragm 51 easily enters the liquid chamber. In this point, both surfaces of the diaphragm 51 are in contact with the liquid. Therefore, even when the first liquid chamber 49 is depressurized, the entry of air into the supply flow path 26 can be prevented.
(1-5) The resistance flow path 29 is provided in the branch flow path 27. The resistance flow path 29 has a cross-sectional area smaller than that of the branch flow path 27. Therefore, the liquid having an appropriate flow rate can flow to the branch flow path 27 with a simple configuration.

### Modified Examples

The present embodiment can be modified and implemented as follows. The present embodiment and the modified examples given below can be implemented in combination with each other as long as no technical inconsistencies are involved.

The liquid supply device 14 may not include the resistance flow path 29. For example, the resistance of the branch flow path 27 may be made larger than the resistance of the supply flow path 26 by making the cross-sectional area of the branch flow path 27 smaller than the cross-sectional area of the supply flow path 26.

The liquid supply device 14 may not include the resistance flow path 29, the parallel flow path 28, and the regulator 30. The liquid supply device 14 may include a circulation valve that opens and closes the branch flow path 27. The liquid supply device 14 may circulate the liquid in the supply flow path 26 between the first coupling portion 38 and the second coupling portion 39 and the branch flow path 27. When the liquid is circulated, the control unit 23 causes the circulation valve to open the branch flow path 27 and drives the liquid feeding portion 31. When the liquid flows through the branch flow path 27, the pressure in the second liquid chamber 50 increases, and thus the supply valve 33 closes the supply flow path 26. Therefore, a pressure for circulating the liquid can be made less likely to affect downstream of the supply valve 33. The liquid supply device 14 may include at least one of the supply valve 33 that closes the supply flow path 26 during circulation and the supply valve 33 that closes the supply flow path 26 during the choke cleaning.

The branch flow path 27 may be a flow path coupling the second coupling portion 39 and the second liquid chamber 50. That is, the liquid supply device 14 may not include the branch flow path 27 between the first coupling portion 38 and the second liquid chamber 50.

The liquid supply device 14 may not include the liquid feeding portion 31 and the pressure regulating valve 34. The liquid supply device 14 may supply the liquid stored in the liquid storage portion 36 to the liquid ejection head 12 by a water head.

The liquid ejection apparatus 11 can be a liquid ejection apparatus that jets or discharges other liquids than an ink. The state of the liquid to be ejected as a minute amount of droplet from the liquid ejection apparatus includes a particle state, a teardrop state, and a state of tailing like a thread. The liquid mentioned here may sufficiently be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include such ink as described in the above embodiment and a liquid crystal. Here, the term ink includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curable resin onto a substrate in order to form a minute hemispherical lens used for an optical communication element or the like, an optical lens, or the like. The liquid ejection apparatus may be an apparatus that ejects an acid or alkali etching solution in order to etch a substrate or the like.

### Definitions

The expression “at least one” used in the present specification means “one or more” of desired options. For example, the expression “at least one” used in the present specification means “only one alternative” or “both of two alternatives” when the number of alternatives is two. As another example, the expression “at least one” used in the present specification means “only one alternative”, “a combination of any two alternatives”, or “a combination of any three or more alternatives” when the number of alternatives is three or more.

### Appendices

Technical ideas understood from the embodiment and the modified examples described above, and the functions and advantages thereof will hereinafter be described.
[1] A liquid ejection apparatus includes: a liquid ejection head configured to eject a liquid from a nozzle; a supply flow path configured to allow the liquid to be supplied from a liquid storage portion storing the liquid to the liquid ejection head; a branch flow path branched from the supply flow path; and a supply valve configured to open and close the supply flow path. The supply valve includes a first liquid chamber provided in the supply flow path, a second liquid chamber provided in the branch flow path, and a diaphragm partitioning the first liquid chamber and the second liquid chamber, the first liquid chamber includes an inflow port into which the liquid flows and an outflow port from which the liquid flows out, and when a pressure of the first liquid chamber is lower than a pressure of the second liquid chamber, the diaphragm is displaced in a direction of reducing a volume of the first liquid chamber to close the outflow port.

According to this configuration, the first liquid chamber is provided in the supply flow path. The diaphragm partitions the first liquid chamber and the second liquid chamber. That is, the liquid in the first liquid chamber comes into contact with one surface of the diaphragm. The liquid in the second liquid chamber comes into contact with the other surface of the diaphragm. Therefore, the entry of air into the supply flow path can be prevented.
[2] The liquid ejection apparatus according to [1] described above may include a liquid feeding portion provided in the supply flow path upstream of the supply valve, and a pressure regulating valve provided in the supply flow path downstream of the supply valve. The liquid feeding portion may feed the liquid in a supply direction, and the pressure regulating valve may open the supply flow path when a downstream pressure is lower than a predetermined pressure.

According to this configuration, the liquid feeding portion feeds the liquid in the supply direction. The pressure regulating valve regulates the pressure of the liquid fed by the liquid feeding portion. Therefore, the liquid can be stably supplied to the liquid ejection head.
[3] In the liquid ejection apparatus according to [1] or [2] described above, the branch flow path may be coupled to a first coupling portion provided in the supply flow path upstream of the liquid feeding portion and a second coupling portion provided in the supply flow path between the liquid feeding portion and the pressure regulating valve.

According to this configuration, the branch flow path is coupled to the first coupling portion upstream of the liquid feeding portion and the second coupling portion downstream of the liquid feeding portion. When the liquid feeding portion feeds the liquid in the supply direction, the liquid also flows into the branch flow path. Therefore, since the liquid in the second liquid chamber can be caused to flow, it is possible to reduce a possibility that foreign matters such as air bubbles stay in the second liquid chamber.
[4] The liquid ejection apparatus according to any one of [1] to [3] described above may include a cap configured to come into contact with the liquid ejection head and form a closed space in which the nozzle opens, and an aspiration unit configured to aspirate the closed space to depressurize the first liquid chamber. When the first liquid chamber is depressurized by the aspiration unit, the diaphragm may be displaced in the direction of reducing the volume of the first liquid chamber to close the outflow port.

In the so-called choke cleaning in which the supply flow path is closed to store the negative pressure and then the liquid is vigorously discharged, the liquid chamber is depressurized. Therefore, when the diaphragm is in contact with air, the air that passes through the diaphragm easily enters the liquid chamber. In this point, according to this configuration, both surfaces of the diaphragm are in contact with the liquid. Therefore, even when the first liquid chamber is depressurized, the entry of air into the supply flow path can be prevented.
[5] The liquid ejection apparatus according to any one of [1] to [4] described above may include a resistance flow path provided in the branch flow path, and a cross-sectional area of the resistance flow path may be smaller than a cross-sectional area of the branch flow path.

According to this configuration, the resistance flow path is provided in the branch flow path. The resistance flow path has a cross-sectional area smaller than that of the branch flow path. Therefore, the liquid having an appropriate flow rate can flow to the branch flow path with a simple configuration.

What is claimed is:

1. A liquid ejection apparatus comprising:
a liquid ejection head configured to eject a liquid from a nozzle;
a supply flow path configured to allow the liquid to be supplied from a liquid storage portion storing the liquid to the liquid ejection head;
a branch flow path branched from the supply flow path; and
a supply valve configured to open and close the supply flow path, wherein
the supply valve includes
a first liquid chamber provided in the supply flow path,
a second liquid chamber provided in the branch flow path, and
a diaphragm partitioning the first liquid chamber and the second liquid chamber,
the first liquid chamber includes an inflow port into which the liquid flows and an outflow port from which the liquid flows out, and
when a pressure of the first liquid chamber is lower than a pressure of the second liquid chamber, the diaphragm is displaced in a direction of reducing a volume of the first liquid chamber to close the outflow port.

2. The liquid ejection apparatus according to claim 1, further comprising:
a liquid feeding portion provided in the supply flow path upstream of the supply valve; and
a pressure regulating valve provided in the supply flow path downstream of the supply valve, wherein
the liquid feeding portion feeds the liquid in a supply direction, and
the pressure regulating valve opens the supply flow path when a downstream pressure is lower than a predetermined pressure.

3. The liquid ejection apparatus according to claim 2, wherein
the branch flow path is coupled to a first coupling portion provided in the supply flow path upstream of the liquid feeding portion and a second coupling portion provided in the supply flow path between the liquid feeding portion and the pressure regulating valve.

4. The liquid ejection apparatus according to claim 1, further comprising:
a cap configured to come into contact with the liquid ejection head and form a closed space in which the nozzle opens; and
an aspiration unit configured to aspirate the closed space to depressurize the first liquid chamber, wherein
when the first liquid chamber is depressurized by the aspiration unit, the diaphragm is displaced in the direction of reducing the volume of the first liquid chamber to close the outflow port.

5. The liquid ejection apparatus according to claim 1, further comprising:
a resistance flow path provided in the branch flow path, wherein
a cross-sectional area of the resistance flow path is smaller than a cross-sectional area of the branch flow path.
